(19) United States
(12) Patent Application Publication
(10) Pub. No.: US 2010/0318584 A1
(43) Pub. Date: Dec. 16, 2010

(54) Distributed Cache Availability During Garbage Collection

(75) Inventors: Muralidhar Krishnaprasad, Redmond, WA (US); Maoni Z. Stephens, Sammamish, WA (US); Lu Xun, Kirkland, WA (US); Anil K. Nori, Redmond, WA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/484,185

(22) Filed: Jun. 13, 2009

(51) Int. Cl. G06F 12/00; G06F 12/08

(52) U.S. Cl. 707/813; 711/118; 707/812

(57) ABSTRACT

Techniques are described herein for managing access to a distributed cache during garbage collection. When garbage collection is to be performed with respect to a node, the node may send a request to a data manager requesting to have an instance of data module(s) included in the node that are in a primary state placed in a secondary state. The data manager may change the state of the data module(s) to the secondary state. The data manager may change the state of another instance of the data module(s) that is included in another node to the primary state. When the garbage collection is complete with respect to the node, the node may send another request to the data manager requesting that the data module(s) that were placed in the secondary state be returned to the primary state. The data manager may return those data module(s) to the primary state.

### BACKGROUND

In the context of computer science, a cache is a collection of data that is a duplicate of original data that is stored elsewhere (e.g., in a database or other data storage system). The data stored in the cache is often a frequently used subset of the original data. For instance, the original data may be expensive to access due to a relatively longer access time, as compared to an access time associated with the cache. Accordingly, it may be desirable to access the data at the cache, rather than at the database or other data storage system.

A distributed cache is a cache in which data is stored on multiple machines (e.g., computers or other processing systems). Distributed caches offer scalability, which often is not available with data storage systems (e.g., relational databases) that store original data. However, distributed caches written in managed code (e.g., Java, common language runtime (CLR), etc.) often encounter bottlenecks with respect to some operations, such as garbage collection operations.

Caches can be used to store objects such as (but not limited to) data structures. The objects may be associated with a unique identifier, such as an address, that allows them to be read or written to by applications. For a variety of reasons, certain objects stored in a cache may no longer be referenced by any applications. In this case, the resources (e.g., memory associated with the cache) required to maintain those objects in the cache are wasted. In order to address this issue, a “garbage collection” operation may be used to identify objects that are not referenced by any applications and reclaim the resources used to maintain those objects.

Typically, a garbage collection operation “locks” an object while the object is being analyzed to determine whether or not the object is referenced by at least one application. Locking an object prevents processes (e.g., processes associated with software applications) from accessing the object. Accordingly, it may appear to an entity managing access to the distributed cache that the machine storing the locked object is non-responsive. The entity may therefore unnecessarily attempt to reconfigure the machine.

Running multiple instances of the distributed cache among the machines to store the same amount of data as a single instance, rather than running a single instance, may reduce the number of objects that are locked during a garbage collection operation. However, running multiple cache instances demands more overhead and may hinder the performance of processes that require data to be all in memory on a single process (e.g., joins, dependency, etc.). In a replicated distributed cache in which each machine stores a respective instance of the same data, load balancing may be used to provide access to an object on one machine if the object is locked on another machine. However, such load balancing is not possible in a partitioned distributed cache in which each machine stores a respective partition of the data.

### SUMMARY

Various approaches are described herein for, among other things, managing access to a distributed cache during a garbage collection operation. The distributed cache is made up of a plurality of nodes that are hosted by a plurality of machines (e.g., computers or other processing systems). Each node includes one or more data modules of the distributed cache. A data module is a respective portion (e.g., partition(s) or other suitable portion) of the distributed cache or a replica of the distributed cache. It should be noted that any portion of the distributed cache may be replicated across multiple nodes. For instance, a first instance of a portion may be included in a first node, a second instance of the portion may be included in a second node, and so on. Moreover, a node may include multiple instances of the same portion of the distributed cache. A “replica of the distributed cache”, however, refers to an instance of all data stored in the distributed cache. A garbage collection operation that is performed with respect to a node may lock instance(s) of data that are included in the node. However, when a portion or all of the distributed cache is replicated across multiple nodes, one or more other instances of the data may be available on other node(s) of the distributed cache so that the performance of the garbage collection operation does not render the data inaccessible to processes (e.g., processes associated with software applications) that attempt to access the data.

A data manager is at least one computer or other processing system(s), including one or more processors, which distributes data modules of the distributed cache among the nodes. In a replication scenario, multiple instances of data modules may be stored in different nodes for “high availability”. The data manager also determines which instances of respective data modules are to be primary instances of the respective data modules and which are to be secondary instances of the data modules. A primary instance of a data module with respect to a cache operation is an instance of the data module at which the cache operation with respect to the data module is initially directed or at which the cache operation with respect to the data module is initiated. Examples of cache operations include but are not limited to a read operation, a write operation, an eviction operation, a notification operation, etc. For example, an instance of a data module to which a read (or write) operation is initially directed with respect to the data module is the primary instance of the data module with respect to that read (or write) operation. In another example, an instance of a data module at which an eviction (or notification) operation is initiated with respect to the data module is the primary instance of the data module with respect to that eviction (or notification) operation. Secondary instances of data modules with respect to cache operations are essentially “back-up” instances of the data modules with respect to the cache operations.

The data manager may be capable of changing the state of instance(s) of data module(s), so that a garbage collection operation may be performed with respect to a first instance of a data module. For example, the data manager may change the state of the first instance of the data module from a primary state to a secondary state. When all instances of data modules that are included in a node are in the secondary state, the node is said to be offline. For instance, cache operations are not initiated at or initially directed to instances of data modules included in a node that is offline because those instances of the data modules are in the secondary state. In another example, the data manager may change the state of a second instance of a data module from a secondary state to a primary state, so that data that is stored in the data module is available during a garbage collection operation.

When a node receives an indication that a garbage collection operation is to be performed with respect to the node, the node may send a request to the data manager requesting to have instances of data module(s) included in the node that are in a primary state placed in a secondary state prior to execution of the garbage collection operation with respect to the node. When the node receives an indication that the garbage collection operation is complete with respect to the node, the node may send another request to the data manager requesting that the instances of the data module(s) that were placed in the secondary state be returned to the primary state.

An example method is described in which a request is received from a node of a distributed cache to place the node in an offline state prior to execution of a garbage collection operation with respect to the node. A state of an instance of data module(s) that is included in the node is changed from a primary state to a secondary state, using processor(s), in response to receiving the request. The primary state of the instance indicates that cache operation(s) with respect to the data module(s) are to be initiated at or initially directed to the instance of the data module(s) that is included in the node. The secondary state of the instance indicates that cache operation(s) with respect to the data module(s) are not to be initiated at or initially directed to the instance of the data module(s) that is included in the node.

Another example method is described in which a request is received from a node of a distributed cache to place the node in an offline state prior to execution of a garbage collection operation with respect to the node. A determination is made, in response to receiving the request from the node, that every instance of data module(s) except for instance(s) of the data module(s) that are included in the node is locked by the garbage collection operation. A request is made that the garbage collection operation be postponed with respect to the node in response to determining that every instance of data module(s) except for instance(s) of the data module(s) that are included in the node is locked by the garbage collection operation.

Yet another example method is described in which a request is received from a node of a distributed cache to place the node in an offline state prior to execution of a garbage collection operation with respect to the node. A load of the node is compared to a threshold in response to receiving the request from the node. A request is made that the garbage collection operation be postponed with respect to the node based on the load exceeding the threshold.

Still another example method is described in which an indicator is received at a node of a distributed cache. The indicator indicates that a garbage collection operation is to be performed with respect to the node. A request is sent from the node, using processor(s) of a machine that hosts the node, to a data manager. The request seeks to have an instance of data module(s) that is included in the node placed in a secondary state prior to execution of the garbage collection operation.

Yet still another example method is described in which an indicator is received at a node of a distributed cache. The indicator indicates that a garbage collection operation is completed with respect to the node. A request is sent from the node, using processor(s) of a machine that hosts the node, to a data manager. The request seeks to have an instance of data module(s) that is included in the node returned from a secondary state to a primary state in response to completion of the garbage collection operation with respect to the node.

An example data manager is described that includes a receiving module and a state module. The receiving module is configured to receive a request from a node of a distributed cache to place the node in an offline state prior to execution of a garbage collection operation with respect to the node. The state module is configured to change a state of an instance of data module(s) that is included in the node from a primary state to a secondary state in response to the request.

A computer program product is also described. The computer program product includes a computer-readable medium having computer program logic recorded thereon for enabling a processor-based system to manage access to a distributed cache during a garbage collection operation. The computer program product includes a first program logic module and a second program logic module. The first program logic module is for enabling the processor-based system to change a state of a first instance of data module(s) that is included in a first node of the distributed cache from a primary state to a secondary state in response to a request from the first node to place the first node in an offline state prior to execution of the garbage collection operation with respect to the first node. The second program logic module is for enabling the processor-based system to change a state of a second instance of the data module(s) that is included in a second node of the distributed cache from the secondary state to the primary state in response to the request.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Moreover, it is noted that the invention is not limited to the specific embodiments described in the Detailed Description and/or other sections of this document. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form part of the specification, illustrate embodiments of the present invention and, together with the description, further serve to explain the principles involved and to enable a person skilled in the relevant art(s) to make and use the disclosed technologies.

FIG. 1 is an example logical representation of a distributed cache.

FIG. 2 is a block diagram of an example routing protocol used to route requests and responses of Put and Get operations in a partitioned distributed cache having primary data partitions.

FIG. 3 is a block diagram of an example routing protocol used to route requests and responses of Put and Get operations in a partitioned distributed cache having primary and secondary data partitions.

FIG. 4 is a block diagram of an example routing protocol used to route requests and responses of Put and Get operations in a replicated distributed cache.

FIG. 5 is a block diagram of an example routing protocol used to route requests and responses of Put and Get operations using local caches.

FIG. 6 is a block diagram of an example computer system that utilizes a distributed cache in accordance with an embodiment.

FIGS. 7 and 8 depict flowcharts of methods for requesting a state change for an instance of data module(s) that is included in a node in accordance with embodiments.

FIG. 9 is a block diagram of an example implementation of a machine shown in FIG. 1 in accordance with an embodiment.

FIGS. 10A-10C depict respective portions of a flowchart of a method for managing access to a distributed cache during a garbage collection operation in accordance with an embodiment.

FIGS. 11, 13, and 15 are block diagrams of example implementations of a data manager shown in FIG. 1 in accordance with an embodiment.

FIGS. 12 and 14 depict flowcharts of methods for managing access to a distributed cache during a garbage collection operation in accordance with embodiments.

FIG. 16 depicts an example computer in which embodiments may be implemented.

The features and advantages of the disclosed technologies will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION

The detailed description begins with an introductory section to introduce some of the concepts that will be discussed in further detail in subsequent sections. An example implementation of a distributed cache is described in the next section. Example embodiments for providing distributed cache availability during garbage collection are then discussed, followed by a conclusion section.

### I. Introduction

The following detailed description refers to the accompanying drawings that illustrate exemplary embodiments of the present invention. However, the scope of the present invention is not limited to these embodiments, but is instead defined by the appended claims. Thus, embodiments beyond those shown in the accompanying drawings, such as modified versions of the illustrated embodiments, may nevertheless be encompassed by the present invention.

References in the specification to “one embodiment,” “an embodiment,” “an example embodiment,” or the like, indicate that the embodiment described may include a particular feature, structure, or characteristic, but every embodiment may not necessarily include the particular feature, structure, or characteristic. Moreover, such phrases are not necessarily referring to the same embodiment. Furthermore, when a particular feature, structure, or characteristic is described in connection with an embodiment, it is submitted that it is within the knowledge of one skilled in the relevant art(s) to implement such feature, structure, or characteristic in connection with other embodiments whether or not explicitly described.

Example embodiments are capable of managing access to a distributed cache during a garbage collection operation. The distributed cache is made up of a plurality of nodes that are hosted by a plurality of machines (e.g., computers or other processing systems). Each node includes one or more data modules of the distributed cache. A data module is a respective portion (e.g., partition(s) or other suitable portion) of the distributed cache or a replica of the distributed cache. It should be noted that any portion of the distributed cache may be replicated across multiple nodes. For example, a first instance of a portion may be included in a first node, a second instance of the portion may be included in a second node, and so on. Moreover, a node may include multiple instances of the same portion of the distributed cache. A “replica of the distributed cache”, however, refers to an instance of all data stored in the distributed cache. A garbage collection operation that is performed with respect to a node may lock instance(s) of data that are included in the node. However, when a portion or all of the distributed cache is replicated across multiple nodes, one or more other instances of the data may be available on other node(s) of the distributed cache so that the performance of the garbage collection operation does not render the data inaccessible to processes (e.g., processes associated with software applications) that attempt to access the data.

A data manager is at least one computer or other processing system(s), including one or more processors, which distributes instances of the data modules of the distributed cache among the machines that host the respective nodes. In a replication scenario, multiple instances of data modules may be stored in different nodes for “high availability” of those data modules. The data manager also determines which instances of respective data modules are to be primary instances of the respective data modules and which are to be secondary instances of the data modules. A primary instance of a data module with respect to a cache operation is an instance of the data module at which the cache operation with respect to the data module is initially directed or at which the cache operation with respect to the data module is initiated. Examples of cache operations include but are not limited to a read operation, a write operation, an eviction operation, a notification operation, etc. For example, an instance of a data module to which a read (or write) operation is initially directed with respect to the data module is the primary instance of the data module with respect to that read (or write) operation. In another example, an instance of a data module at which an eviction (or notification) operation is initiated with respect to the data module is the primary instance of the data module with respect to that eviction (or notification) operation. Secondary instances of data modules with respect to cache operations are essentially “back-up” instances of the data modules with respect to the cache operations.

In accordance with example embodiments, a data manager is capable of changing the state of instance(s) of data module(s), so that a garbage collection operation may be performed with respect to a primary data module. For example, the data manager may change the state of the first instance of the data module from a primary state to a secondary state. When all instances of data modules that are included in a node are in the secondary state, the node is said to be offline. For instance, cache operations are not initiated at or initially directed to data modules included in a node that is offline because those instances of the data modules are in the secondary state. In another example, the data manager may change the state of a second instance of a data module from a secondary state to a primary state, so that data that is stored in the data module is available during the garbage collection operation.

In accordance with example embodiments, when a node receives an indication that a garbage collection operation is to be performed with respect to the node, the node sends a request to a data manager. The request seeks to have an instance of data module(s) that is included in the node and that is in a primary state placed in a secondary state prior to execution of the garbage collection operation with respect to the node. When the node receives an indication that the garbage collection operation is complete with respect to the node, the node may send another request to the data manager requesting that the instance of the data module(s) that was placed from the primary state to the secondary state be returned from the secondary state to the primary state.

### II. Example Implementation of a Distributed Cache

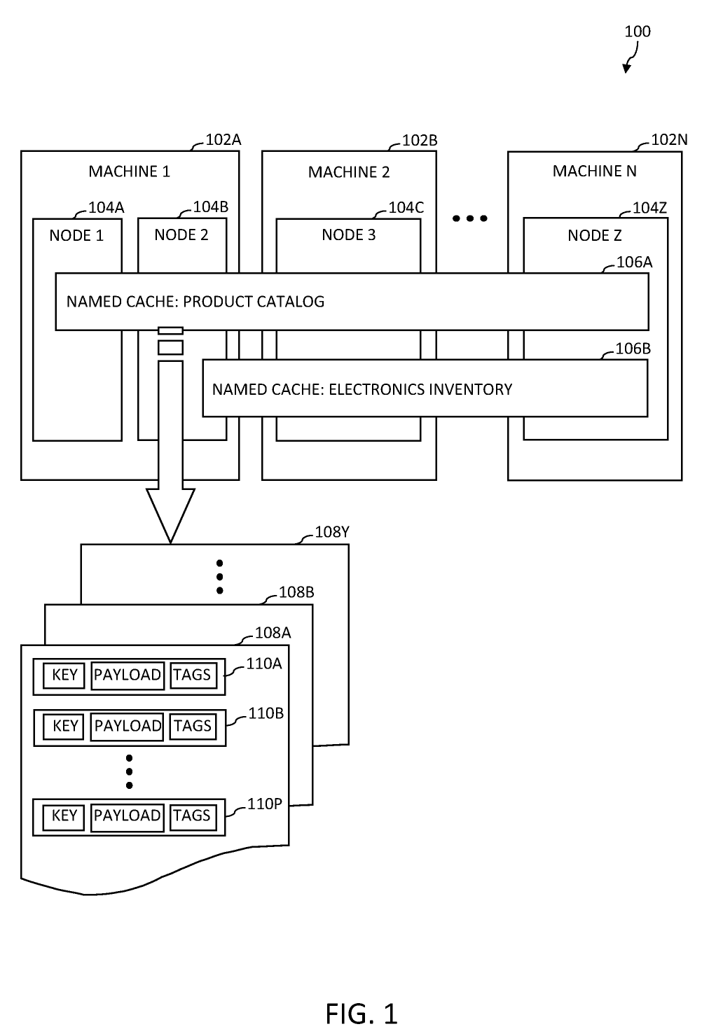

FIG. 1 is an example logical representation of a distributed cache 100. A distributed cache is a cache in which data is stored on a plurality of machines (e.g., machines 102A-102N). A machine is a computer (e.g., server) or other processing system that is configured to support one or more nodes of a distributed cache. Each node includes one or more data modules of the distributed cache. A data module is a respective portion (e.g., partition(s) or other suitable portion) of the distributed cache or a replica of the distributed cache. It should be noted that any portion of the distributed cache may be replicated across multiple nodes. For instance, a first instance of a portion may be included in a first node, a second instance of the portion may be included in a second node, and so on. Moreover, a node may include multiple instances of the same portion of the distributed cache. A “replica of the distributed cache”, however, refers to an instance of all data stored in the distributed cache.

Distributed cache 100 includes named caches 106A and 106B. A named cache is a logical grouping of data. A named cache may be thought of as a database for ease of discussion, though the scope of the example embodiments is not limited in this respect. Named caches 106A and 106B specify physical configurations and cache policies, including but not limited to failover, expiration, eviction, etc. Applications that need to communicate with a designated distributed cache (e.g., distributed cache 100) instantiate the same named cache.

An application may use one or more named caches based on the policies for the various caches. For example, a first type of data (e.g., activity data) may be stored in a named cache that is partitioned, while a second type of data (e.g., reference data) may be stored in a named cache that is replicated. Partitioned and replicated distributed caches are discussed in greater detail below.

Two named caches (i.e., named caches 106A and 106B) are shown in FIG. 1 for illustrative purposes and are not intended to be limiting. Persons skilled in the relevant art(s) will recognize that distributed cache 100 may include any number of named caches. Named cache 106A is shown to store data associated with a product catalog, and named cache 106B is shown to store data associated with an electronics inventory, though it will be recognized that named caches may store any suitable groupings of data.

Each of the nodes 104A-104Z (a.k.a. “cache hosts”) includes one or more data modules of distributed cache 100. A data module is a respective portion (e.g., partition(s) or other suitable portion) of the distributed cache or a replica of the distributed cache. It should be noted that any portion of the distributed cache may be replicated across multiple nodes. For instance, a first instance of a portion may be included in a first node, a second instance of the portion may be included in a second node, and so on. Moreover, a node may include multiple instances of the same portion of the distributed cache. A “replica of the distributed cache”, however, refers to an instance of all data stored in the distributed cache. Nodes 104A-104Z are referred to collectively as “the cluster.”

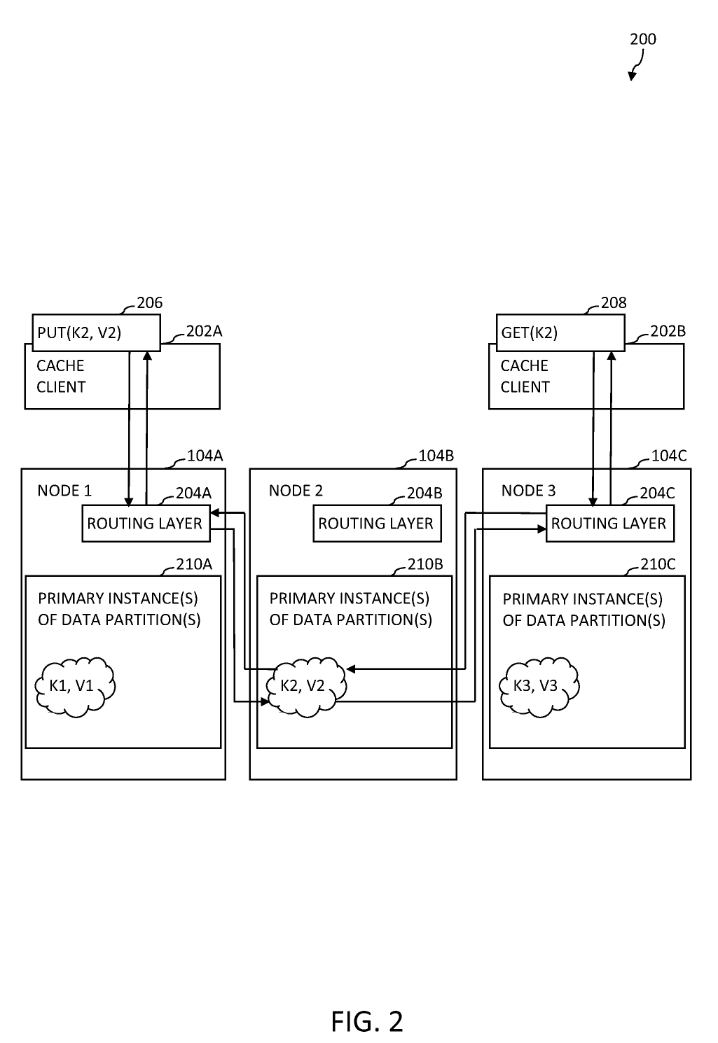

Each of the named caches 106A and 106B includes one or more regions. A region is a logical grouping of objects in a named cache. For instance, named cache 106A is shown in FIG. 1 to include regions 108A-108Y for illustrative purposes. Accordingly, each data module among nodes 104A-104Z may include one or more respective regions of named cache 106A and/or named cache 106B. A region may be thought of as a table for ease of discussion, though the scope of the embodiments is not limited in this respect. For instance, a region may store arbitrary sets of key value pairs. A key value pair includes a key and a corresponding value. A key may be a string of characters, for example, that is used to find a location in distributed cache 100. The value is data (e.g., an object) that corresponds to the location indicated by the key. Further discussion of key value pairs is provided below with reference to FIGS. 2-5.

It should be noted that an application need not necessarily specify a region in order to access a named cache (e.g., named cache 106A or 106B). For instance, the application may use put, get, and remove application programming interfaces (APIs) using only a key to a corresponding object. In fact, the application may scale better when not using regions because key value pairs that are written by the application can be distributed across a named cache without regard for region. For example, if no region is specified during the creation and writing of key value pairs, the key value pairs may be automatically partitioned into multiple implicitly created regions, for example.

Each region 108A-1008Y includes one or more cache items. As shown in FIG. 1, region 108A includes cache items 110A-110P for illustrative purposes. A cache item represents the lowest level of caching that includes the object to be cached along with other information which may include but is not limited to a key, an object payload, one or more tags, a time to live (TTL), created timestamp, a version number, other internal bookkeeping information, etc. Each of the cache items 110A-110P is shown to include a key, a payload, and tags for illustrative purposes, though it will be recognized that the example embodiments are not limited in this respect. For example, cache items 110A-110P need not necessarily include respective keys, payloads, and/or or tags. In another example, cache items 110A-110P may include information in addition to or in lieu of the keys, payloads, and/or tags shown in FIG. 1. The following is an example of C# code that shows the creation of a named cache and region:

//CacheFactory class provides methods to return cache objects
//Create instance of CacheFactory (reads appconfig)
CacheFactory fac = new CacheFactorc( );
//Get a named cache from the factory
Cache catalog = fac.GetCache(“catalogcache”);
//-----------------------------------------------------------
//Simple Get/Put
catalog.Put(“toy-101”, new Toy(“Thomas”, .,.));
//From the same or a different client
Toy toyObj = (Toy)catalog.Get(“toy-101”);
//-----------------------------------------------------------
//Region based Get/Put
catalog.CreateRegion(“toyRegion”);
//Both toy and toyparts are put in the same region
catalog.Put(“toyRegion”, “toy-101”, new Toy( .,.));
catalog.Put(“toyRegion”, “toypart-100”, new ToyParts(...));
Toy toyObj = (Toy)catalog.Get(“toyRegion”, “toy-101”);

The example code provided above is not intended to be limiting. It will be recognized that any suitable type of code may be used to create a named cache and/or a region.

In a replication scenario, multiple instances of data modules may be stored across nodes 104A-104Z for “high availability”. Each of the nodes 104A-104Z may be a primary node or a secondary node with respect to any one or more data modules of distributed cache 100. A primary node is a node that includes a primary instance of a designated data module. For instance, access to the designated data module is routed to the primary node for the designated data module. A secondary node is a node that includes a secondary instance of a designated region. For instance, if a named cache is configured to have “backup instances” of a data module for high availability, then a primary node is specified for providing access to the data module, and one or more other nodes are chosen to include one or more respective secondary instances of the data module in case the primary instance becomes inaccessible, for example. Changes that are made to the primary instance of the data module are reflected in the secondary instances. Such changes may be provided to the secondary instances synchronously or asynchronously. In the asynchronous approach, if the primary node for a data module fails, the secondary node(s) can be used to read data that is stored in the data module without having to have logs written to disk. For instance, failure of the primary node causes a secondary node to become the primary node, so that the data module remains accessible.

A node may be a primary node with respect to one or more first data modules and a secondary node with respect to one or more second data modules of the same distributed cache. For example, if the node is specified to have the primary instance of the first data module(s), the node is considered to be a primary node with respect to the first data module(s). Any other nodes that include an instance of a first data module but do not provide access to that first data module are considered to be secondary nodes with respect to that first data module. If the node does not provide access to the second data module(s), the node is considered to be a secondary node with respect to the second data module(s). A node that provides access to a second data module is considered to be a primary node with respect to that second data module.

Distributed cache 100 may be any of a variety of cache types, including but not limited to a partitioned cache, replicated cache, or local cache. It should be recognized that each of these types of distributed cache may include multiple instances of any one or more data modules. For example, a plurality of instances of a data module may be stored in a plurality of respective nodes of the distributed cache. In another example, a plurality of instances of a data module may be stored on a common node. One instance of each data module may be designated as the primary instance of the respective data module. Other instances of the data modules are designated as secondary instances of the respective data modules.

Applications may choose the appropriate type of cache based on the type of data to be cached, for example. A partitioned cache is a cache that includes regions that are partitioned among the nodes on which a named cache is defined. The combined memory of the machines across the cluster (e.g., machines 102A-102N) can be used to cache data, which may increase the amount of memory available to distributed cache 100. All cache operations associated with a data partition are initiated at or initially directed to the node(s) that contain the primary instance(s) of the data partition with respect to the respective cache operations.

A partitioned cache may be used to achieve a desired scale. For instance, machines and/or nodes may be added to distributed cache 100 to enable automatic load balancing to occur. For instance, some partitions that are stored among machines 102A-102N (or nodes 104A-104Z) may be migrated to the added machines and/or nodes. Such automatic load balancing may result in keys being distributed across the revised cluster. Access requests may be routed to more machines, which may result in an increased throughput. Additional machines may provide additional memory. Additional memory may enable distributed cache 100 to store more data.

FIG. 2 is a block diagram of an example routing protocol 200 used to route requests and responses of Put and Get operations 206, 208 in a partitioned distributed cache having primary instance(s) of data partition(s) 210A-210C. Each of primary instance(s) 210A-210C includes one or more primary instances of one or more respective data partitions. It should be noted that in the embodiment of FIG. 2 no replicas of data partitions are included in nodes 104A-104C because each of the nodes 104A-104C includes only primary instance(s) of respective data partition(s). Only one instance of a data partition can be a primary instance at a given time. A Put operation (e.g., Put operation 206) writes data in a distributed cache (e.g., distributed cache 100). A Get operation (e.g., Get operation 208) reads data from a distributed cache (e.g., distributed cache 100). The Put and Get operations 206, 208 are performed by respective cache clients 202A, 202B.

A cache client is a software application that communicates with a node for writing and/or reading data with respect to data partitions in a distributed cache. A cache client may be configured as a simple cache client or a routing cache client. A simple cache client is a cache client that is configured to contact one node (e.g., one of nodes 104A-104C) in a cluster. The simple cache client has no routing capabilities and does not track where each cached object is stored in the distributed cache. If a simple cache client requests an object from a node that does not store the object or that is not the primary node for that object, that node retrieves the object from the cluster and then returns the object to the simple cache client. A routing client, on the other hand, is a cache client that has routing capabilities. The routing cache client includes a routing table to keep track of cached object placement across the nodes (e.g., nodes 104A-104C) in the cluster. Because the routing cache client keeps track of where each of the cached objects are, the routing cache client can make requests directly to the node that stores the object in memory.

As shown in FIG. 2, cache clients 202A and 202B are configured as simple cache clients for illustrative purposes. It will be recognized, however, that any one or more of cache clients 202A or 202B may be configured as a routing cache client. In FIG. 2, Put operation 206 assigns a value “V2” for a key “K2”. A routing layer 204A of node 104A determines that the key “K2” is associated with node 104B. Accordingly, routing layer 204A routes the request that is associated with Put operation 206 to primary data partition 210B of node 104B. A routing layer 204C routes a request corresponding to Get operation 208 for the key “K2” to primary data partition 210B, as well. It should be noted that routing layers may be incorporated into cache clients. Accordingly, routing layer 204A may be incorporated into cache client 202A, and/or routing layer 204C may be incorporated into cache client 202B.

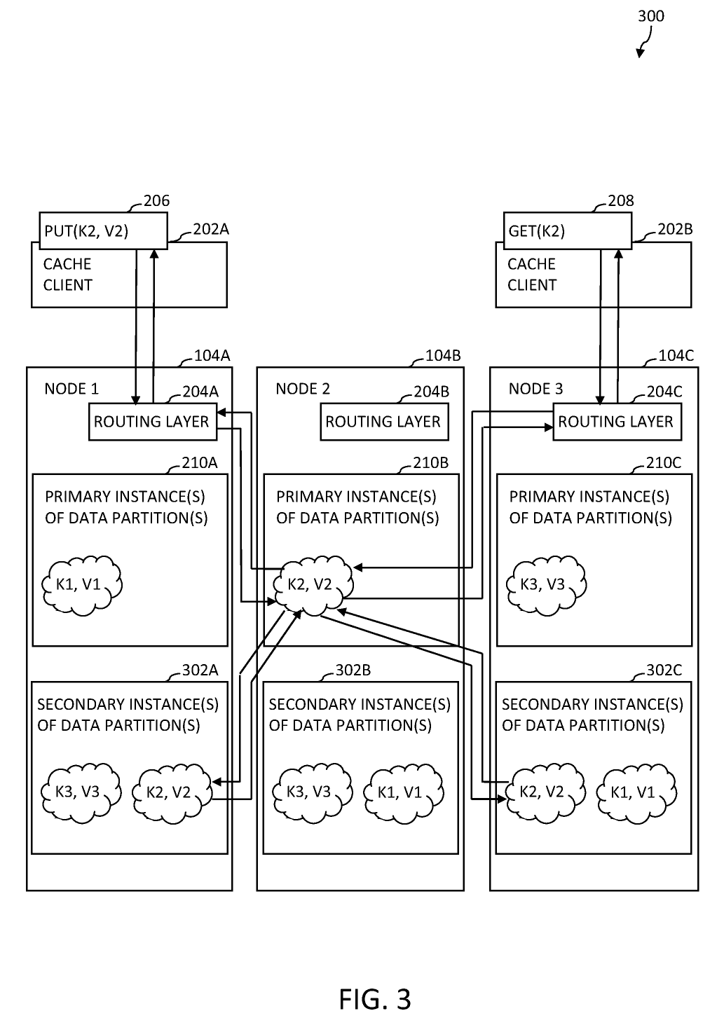

FIG. 3 is a block diagram of an example routing protocol 300 used to route requests and responses of Put and Get operations 206, 208 in a partitioned distributed cache having primary instance(s) of data partition(s) 210A-210C and secondary instance(s) of data partition(s) 302A-302C. Data (e.g., key value pairs “K1, V1”, “K2, V2”, and “K3, V3”) are replicated across nodes 104A-104C, though data partitions 210A-210C and 302A-302C are not replicated. As shown in FIG. 3, cache client 202A sends a request to put the value “V2” with the key “K2” to node 104A. Routing layer 204A determines that the key “K2” belongs to node 104B and therefore routes the key “K2” to node 104B. Node 104B performs Put operation 206 locally and also sends the put request corresponding to Put operation 206 to secondary nodes 104A and 104C. Nodes 104A and 104C are deemed to be secondary nodes with respect to the key value pair “K2, V2” because nodes 104A and 104C include secondary instances of the key value pair “K2, V2.” Node 104B waits for an acknowledgement from nodes 104A and 104C that the request for the key value pair “K2, V2” has been received from node 104B. Upon receiving such acknowledgement, node 104B provides an indicator acknowledging success of the Put operation to node 104A. Node 104A forwards the indicator to cache client 202A.

Get operation 208 is performed in a manner similar to that discussed above with reference to FIG. 2. For instance, routing layer 204C routes the request corresponding to Get operation 208 to primary data partition 210B, which includes the key “K2.”

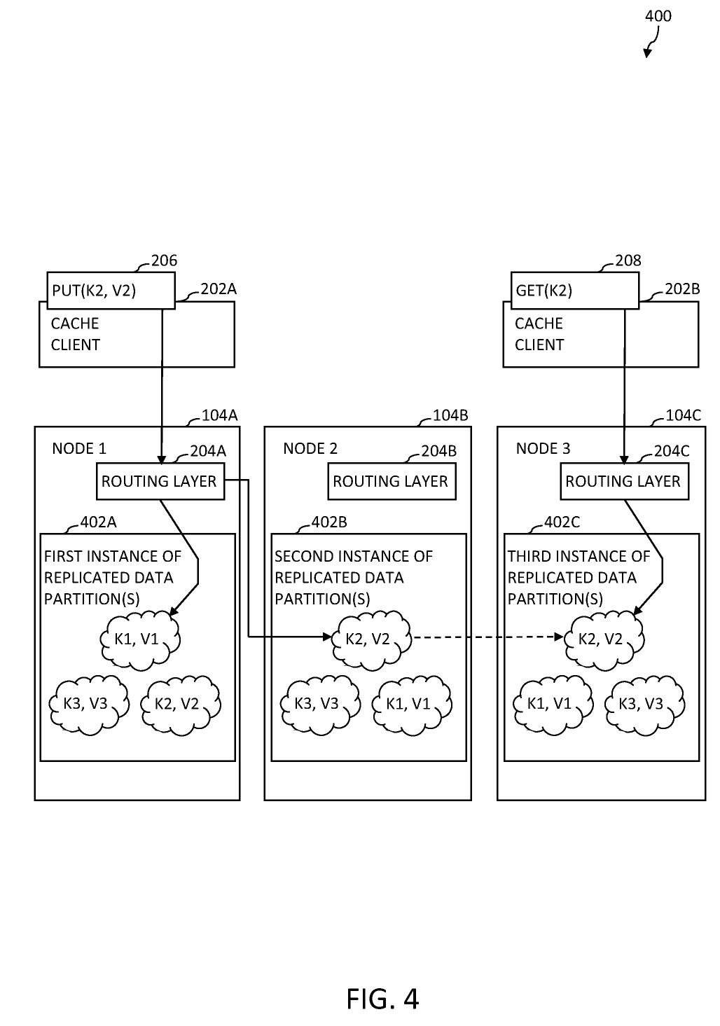

FIG. 4 is a block diagram of an example routing protocol 400 used to route requests and responses of Put and Get operations 206, 208 in a replicated distributed cache. As shown in FIG. 4, nodes 104A-104C include respective instances of replicated data partition(s) 402A-402C. Each instance of the replicated data partitions 402A-402C includes key value pairs “K1, V1”, “K2, V2”, and “K3, V3.” Cache client 202A provides a Put request corresponding to Put operation 206 to node 104A. The Put request includes the key “K2” and the value “V2.” Node 104A routes the Put request to node 104B via routing layer 204A because node 104B is the primary node for the key “K2” in this example. Node 104B performs a write operation locally in response to receiving the Put request. Node 104B provides a notification to node 104A indicating that node 104B has performed the write operation. Node 104A forwards the notification to cache client 202A. Node 104B meanwhile asynchronously propagates the change to all other nodes of the distributed cache (e.g., node 104C in this example). Get operation 208 is performed locally in the replicated distributed cache.

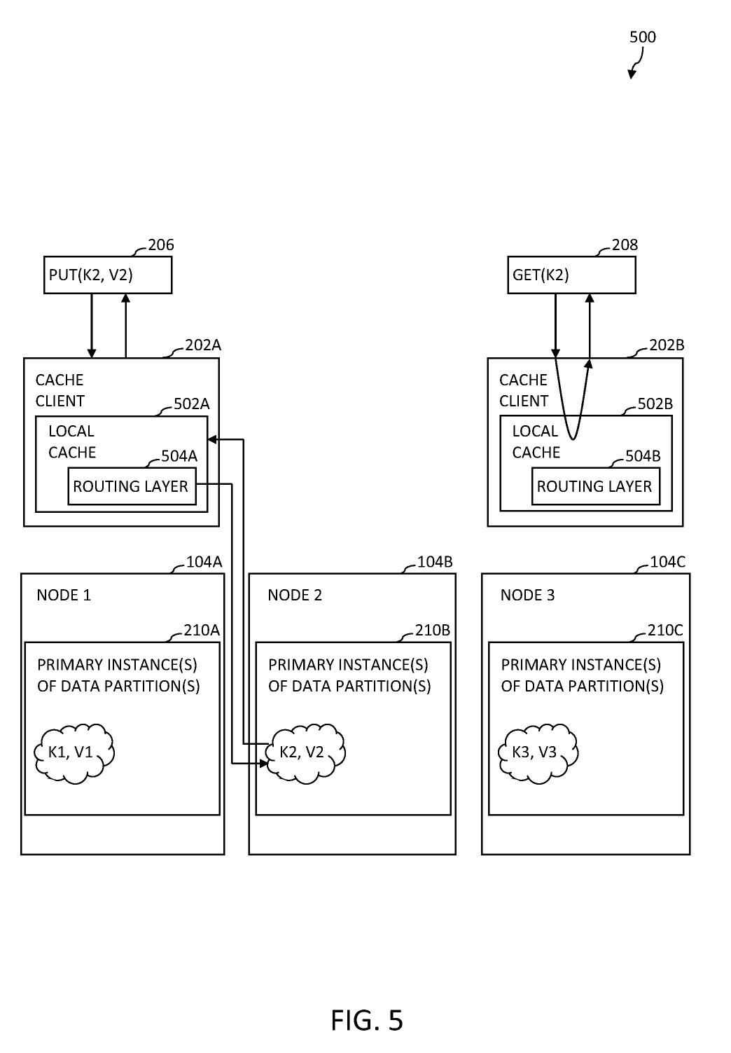

FIG. 5 is a block diagram of an example routing protocol 500 used to route requests and responses of Put and Get operations 206, 208 using local caches 502A, 502B. As shown in FIG. 5, cache clients 202A, 202B include respective local caches 502A, 502B. For instance, applications may maintain a local cache in the application process space for frequently accessed items. Each local cache 502A, 502B is shown to include a respective routing layer 504A, 504B. In local caches 502A, 502B, payload may be kept in the object form to save the deserialization cost and/or the network hop to the primary node, for example, which may improve performance of the distributed cache.

### III. Example Embodiments for Managing Access to a Distributed Cache During Garbage Collection

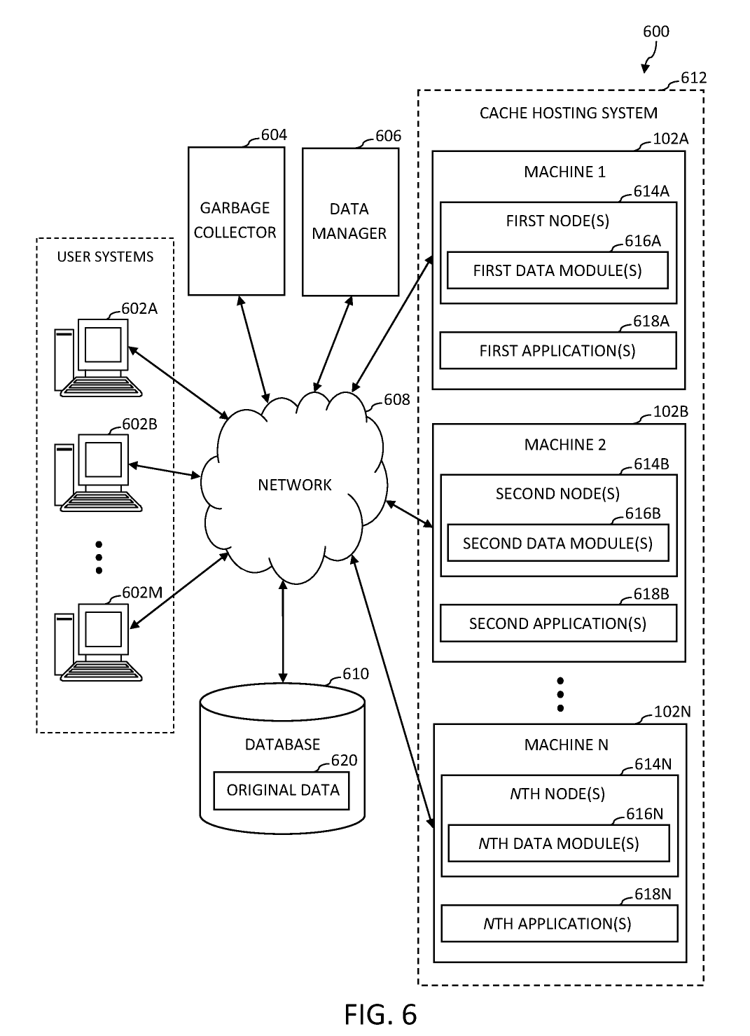

FIG. 6 is a block diagram of an example computer system 600 that utilizes a distributed cache (e.g., distributed cache 100 shown in FIG. 1) in accordance with an embodiment. Generally speaking, computer system 600 operates to store instances of data (e.g., objects) among nodes of the distributed cache. As shown in FIG. 6, computer system 600 includes a plurality of user systems 602A-602M, a garbage collector 604, a data manager 606, a network 608, a database 610, and a cache hosting system 612. Cache hosting system 612 includes a plurality of machines 102A-102N, which are discussed in greater detail below. Communication among user systems 602A-602M, garbage collector 604, data manager 606, database 610, and machines 102A-102N is carried out over network 608 using well-known network communication protocols. Network 608 may be a wide-area network (e.g., the Internet), a local area network (LAN), another type of network, or a combination thereof.

User systems 602A-602M are computers or other processing systems, each including one or more processors, that are capable of communicating with machines 102A-102N. User systems 602A-602M are capable of accessing data that is stored in the distributed cache, which is hosted by cache hosting system 612. The distributed cache includes nodes 614A-614N, which are hosted by respective machines 102A-102N. For example, user systems 602A-602M may be configured to provide Put requests to machines 102A-102N for requesting to write data thereto. In another example, user systems 602A-602M may be configured to provide Get requests to machines 102A-102M for requesting to read data that is stored thereon. For instance, a user may initiate a Put request or a Get request using a client deployed on a user system 602 that is owned by or otherwise accessible to the user.

Cache hosting system 612 hosts the distributed cache. Cache hosting system 612 includes a plurality of machines 102A-102N. Machines 102A-102N are computers or other processing systems, each including one or more processors, that are capable of communicating with user systems 602A-602M. Machines 102A-102N are configured to host respective node(s) 614A-614N. Each node includes respective data module(s) of the distributed cache. As shown in FIG. 1, first node(s) 614A include first data module(s) 616A, second node(s) 614B include second module(s) 616B, and so on.

A data module is a respective portion (e.g., cache item(s), region(s), partition(s), etc.) of the distributed cache or a replica of the distributed cache. It should be noted that any portion of the distributed cache may be replicated across nodes 614A-614N. For instance, a first instance of a portion may be included in a node of the first node(s) 614A, a second instance of the portion may be included in a node of the second node(s) 614B, and so on. Moreover, a node may include multiple instances of the same portion of the distributed cache. For example, a node of the first node(s) 614A may include two or more instances of a cache item(s), region(s), data partition(s), or any other suitable portion of the distributed cache. A “replica of the distributed cache”, however, refers to an instance of all data stored in the distributed cache. A garbage collection operation that is performed with respect to a node may lock instance(s) of data that are included in the node. However, when a portion or all of the distributed cache is replicated across nodes 614A-614N, one or more other instances of the data may be available on other node(s) of the distributed cache so that the performance of the garbage collection operation does not render the data inaccessible to processes (e.g., processes associated with applications 618A-618N) that attempt to access the data.

Any number of instances of a data module may be stored among nodes 614A-614N, though only one instance of the data module may be specified as the primary instance of that data module with respect to a cache operation at a given time. The primary instance of the data module with respect to a cache operation is said to be in a primary state with respect to the cache operation, and any other instances are said to be in a secondary state with respect to the cache operation. It should be noted that a node that includes a primary instance of a data module is referred to as the primary node for that data module. Nodes that include secondary instances of a data module are referred to as secondary nodes for that data module. It will be recognized that a node may be the primary node for some data modules and a secondary node for other data modules.

Any of a variety of applications may be deployed on machines 102A-102N. As shown in FIG. 6, first application(s) 618A are deployed on machine 102A, second application(s) 618B are deployed on machine 102B, and so on. Application(s) 618A-618N may perform operations that create new data to be written to the distributed cache or that read or modify existing data that is stored in the distributed cache. For instance, applications 618A-618N may use Put requests and Get requests to respectively write and read data across machines 102A-102N. In some example embodiments, user systems 602A-602M are capable of accessing one or more of the applications 618A-618N without having to go through network 608. Any one or more of the application(s) 618A-618N may be deployed on a respective user system 602A-602M, in addition to or in lieu of being deployed on a respective machine 102A-102N.

Caches can be used to store objects such as (but not limited to) data structures. The objects may be associated with a unique identifier, such as an address, that allows them to be read or written to by applications. For a variety of reasons, certain objects stored in a cache may no longer be referenced by any applications. In this case, the resources (e.g., memory associated with the cache) required to maintain those objects in the cache are wasted. In order to address this issue, a “garbage collection” operation may be used to identify objects that are not referenced by any applications and reclaim the resources used to maintain those objects.

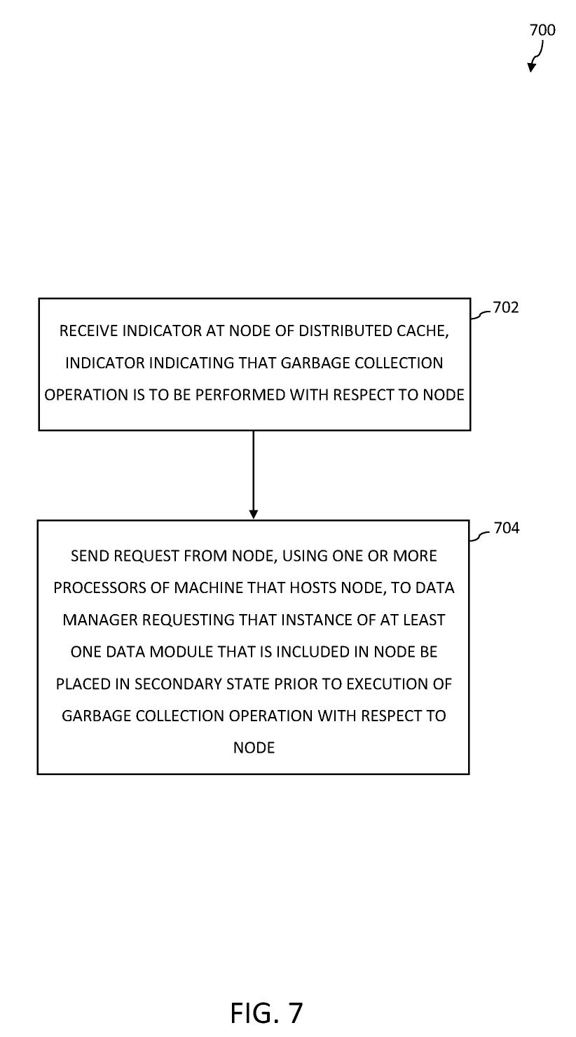

Garbage collector 604 may “lock” an instance of an object while that instance of the object is being analyzed in accordance with a garbage collection operation to determine whether or not the object is referenced by at least one application. Locking an instance of an object prevents processes (e.g., processes associated with application(s) 618A-618N) from accessing that instance of the object. It will be recognized, however, that the distributed cache may include other instance(s) of the object, which may accessible during the garbage collection operation, so long as those instance(s) are in a primary state and are not locked by a garbage collection operation. Techniques for managing access to objects in the distributed cache during a garbage collection operation are discussed in greater detail below with reference to data manager 606 and the example embodiments depicted in FIGS. 7-15.

Garbage collector 604 is shown in FIG. 6 to be a standalone computer(s) or processing system(s) for illustrative purposes and is not intended to be limiting. It will be recognized that garbage collector 604 may be partially or entirely incorporated into cache hosting system 612. For instance, a portion or all of garbage collector 604 may be stored on one of the machines 102A-102N or distributed among any two or more of the machines 102A-102N.

Data manager 606 is at least one computer or other processing system(s), including one or more processors, which distributes instances of data modules of the distributed cache among machines 102A-102N. Data manager 606 also determines which instances of respective data modules are to be primary data modules and which are to be secondary data modules.

Data manager 606 is configured to manage access to the distributed cache during garbage collection operations. For example, data manager 606 may be configured to ensure that instances of data modules that are included in a node are in a secondary state before a garbage collection operation is performed with respect to the node. In this example, data manager 606 may change the state of another instance of the data module that is included in another node to a primary state, so that the data in the data module is accessible during the garbage collection operation. If the node upon which the garbage collection operation is to be performed includes the only instance of the data module in the distributed cache, data manager 606 may generate another instance of the data module to be included in another node, so that the new instance may be set as the primary instance of the data module during performance of the garbage collection operation. Further discussion of techniques for managing access to the distributed cache during garbage collection operations is provided below with reference to FIGS. 7-15.

Data manager 606 is shown in FIG. 6 to be a standalone computer(s) or processing system(s) for illustrative purposes and is not intended to be limiting. It will be recognized that data manager 606 may be partially or entirely incorporated into cache hosting system 612. For instance, a portion or all of data manager 606 may be stored on one of the machines 102A-102N or distributed among any two or more of the machines 102A-102N.

Database 610 is configured to store original data 620 in a structured manner in accordance with a database model (e.g., a relational model, a hierarchical model, a network model, etc.). User systems 602A-602M and/or machines 102A-102N may access the original data 620 in accordance with query language(s), including but not limited to structured query language (SQL), SPARQL, extensible markup language path language (XPath), etc. Any one or more data modules 616A-616C of the distributed cache may store a frequently used subset of original data 620, for example. Original data 620 may be expensive to access due to a relatively longer access time associated with database 610, as compared to an access time associated with the distributed cache. Accordingly, it may be desirable to access the data at the nodes 614A-614N, rather than at database 610.

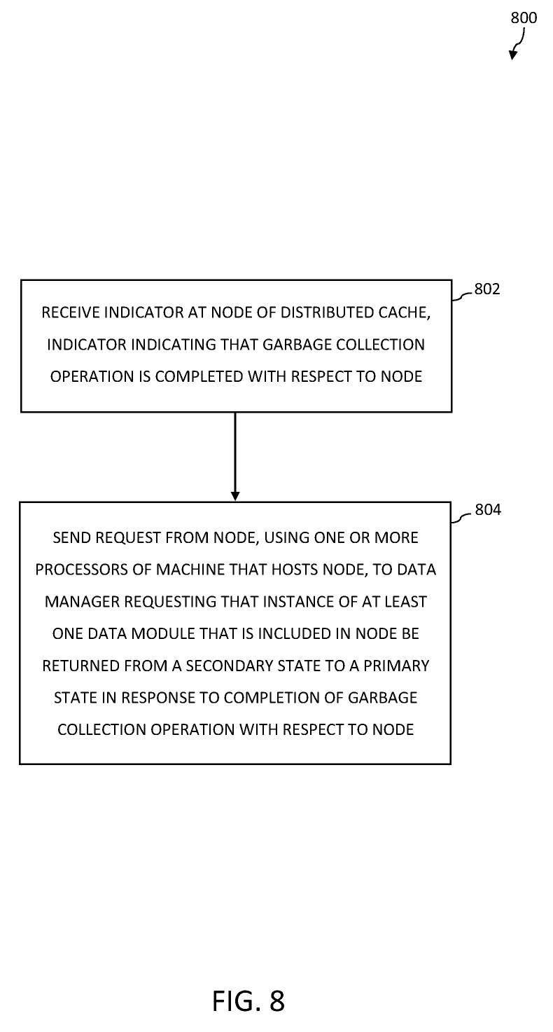

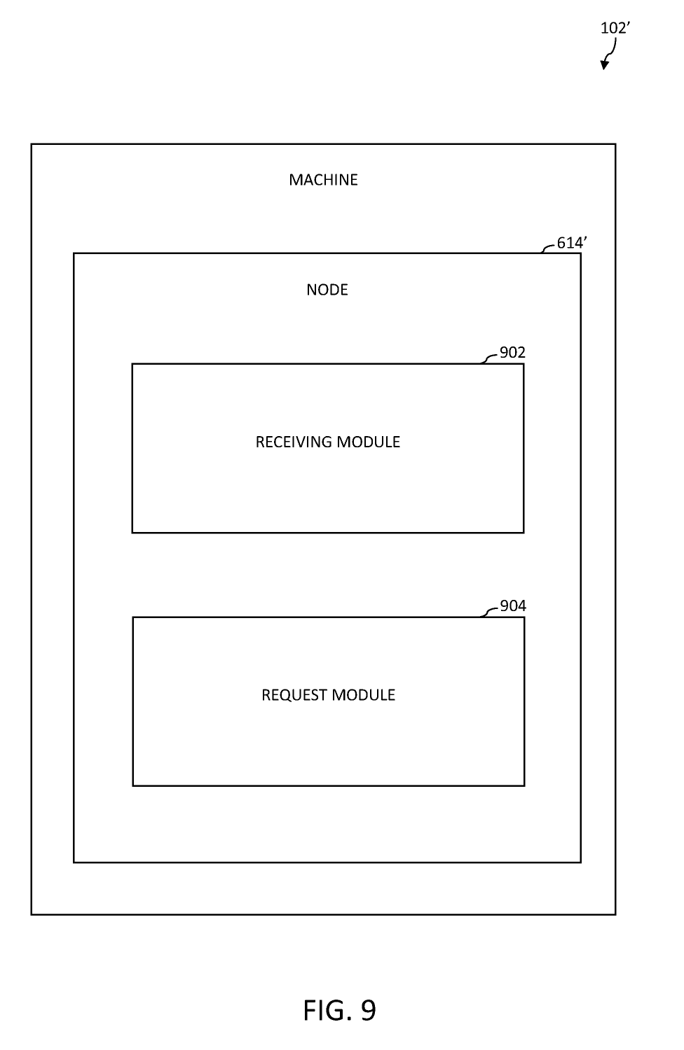

FIGS. 7 and 8 depict flowcharts 700, 800 of methods for requesting a state change for an instance of data module(s) that is included in a node in accordance with embodiments. Flowcharts 700 and 800 are described from the perspective of a machine that hosts a node of a distributed cache. Flowcharts 700 and 800 may be performed by any of machines 102A-102N of cache hosting system 612 shown in FIG. 6, for example. For illustrative purposes, flowcharts 700 and 800 are described with respect to a machine 102′ shown in FIG. 9, which is an example of a machine 102, according to an embodiment. In this document, whenever a prime is used to modify a reference number, the modified reference number indicates an example (or alternate) implementation of the element that corresponds to the reference number.

As shown in FIG. 9, machine 102′ includes a node 614′. Node 614′ includes a receiving module 902 and a request module 904. Further structural and operational embodiments will be apparent to persons skilled in the relevant art(s) based on the discussion regarding flowcharts 700 and 800. Flowchart 700 is described as follows.

As shown in FIG. 7, the method of flowchart 700 begins at step 702. In step 702, an indicator is received at a node of a distributed cache. The indicator indicates that a garbage collection operation is to be performed with respect to the node. For instance, the node may receive the indicator from a garbage collector (e.g., garbage collector 604) that is to perform the garbage collection operation. In an example implementation, receiving module 902 of node 614′ in FIG. 9 receives the indicator.

At step 704, a request is sent from the node, using one or more processors of a machine that hosts the node, to a data manager requesting that an instance of at least one data module that is included in the node be placed in a secondary state prior to execution of the garbage collection operation with respect to the node. The primary state of the instance indicates that cache operation(s) with respect to the at least one data module are to be initiated at or initially directed to the instance of the at least one data module that is included in the node. A secondary state of the instance indicates that the cache operation(s) with respect to the at least one data module are not to be initiated at or initially directed to the instance of the at least one data module that is included in the node.

For example, the node may request that any instance of a data module included in the node that is in a primary state be placed in the secondary state. In another example, the node may request that an instance of one or more selected data module(s) included in the node that are in the primary state be placed in the secondary state. In an example implementation, request module 904 sends the request. For instance, the request may be sent using one or more processors of machine 102′.

As shown in FIG. 8, the method of flowchart 800 begins at step 802. In step 802, an indicator is received at a node of a distributed cache. The indicator indicates that a garbage collection operation is completed with respect to the node. For instance, the node may receive the indicator from a garbage collector (e.g., garbage collector 604) that performed the garbage collection operation. In an example implementation, receiving module 902 of node 614′ in FIG. 9 receives the indicator.

At step 804, a request is sent from the node, using one or more processors of a machine that hosts the node, to a data manager requesting that an instance of at least one data module that is included in the node be returned from a secondary state to a primary state in response to completion of the garbage collection operation with respect to the node.

The primary state of the instance indicates that cache operation(s) with respect to the at least one data module are to be initiated at or initially directed to the instance of the at least one data module that is included in the node. A secondary state of the instance indicates that the cache operation(s) with respect to the at least one data module are not to be initiated at or initially directed to the instance of the at least one data module that is included in the node.

For example, the node may request that any instance of a data module included in the node that was placed in the secondary state in anticipation of performance of the garbage collection operation be returned to the primary state. In another example, the node may request that an instance of one or more selected data modules included in the node that were placed in the secondary state in anticipation of performance of the garbage collection operation be returned to the primary state. In an example implementation, request module 904 sends the request to the data manager. For instance, the request may be sent using one or more processors of machine 102′.

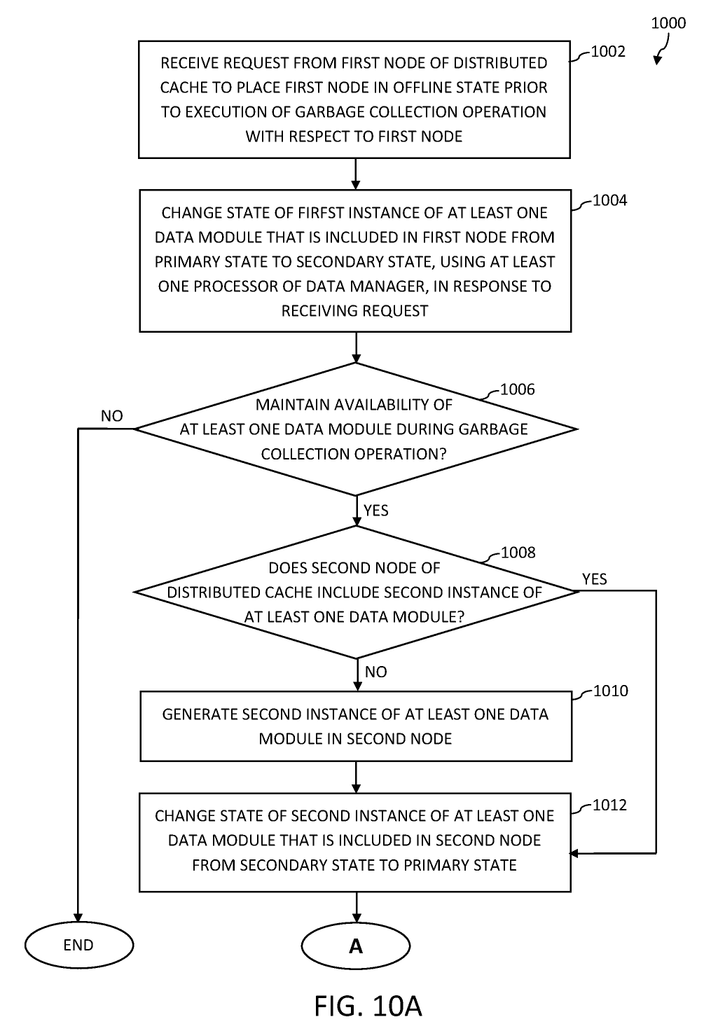

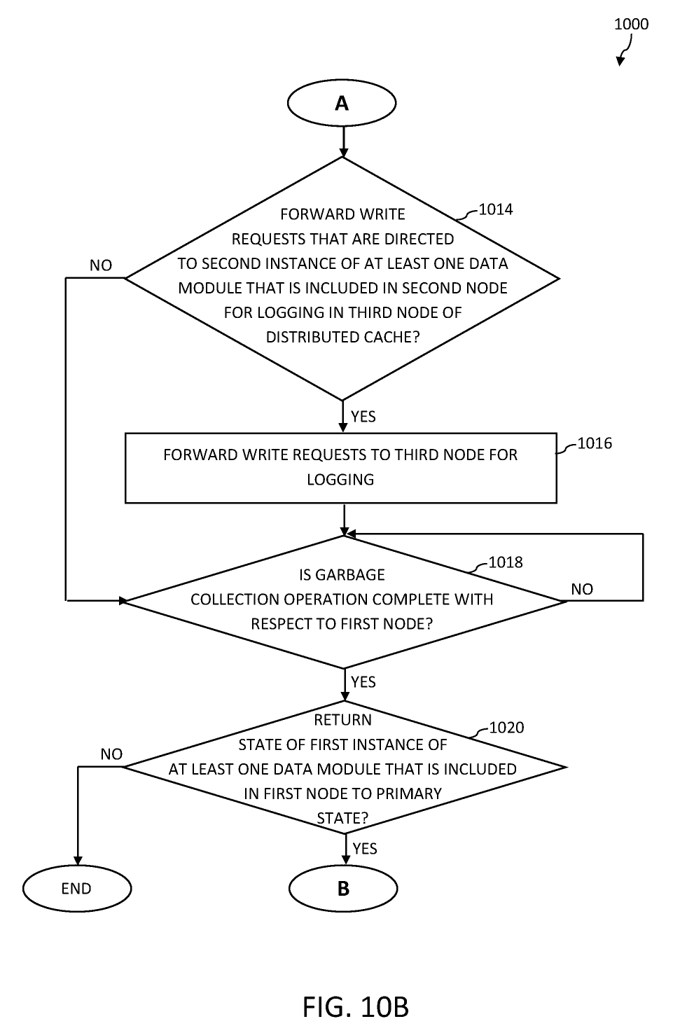

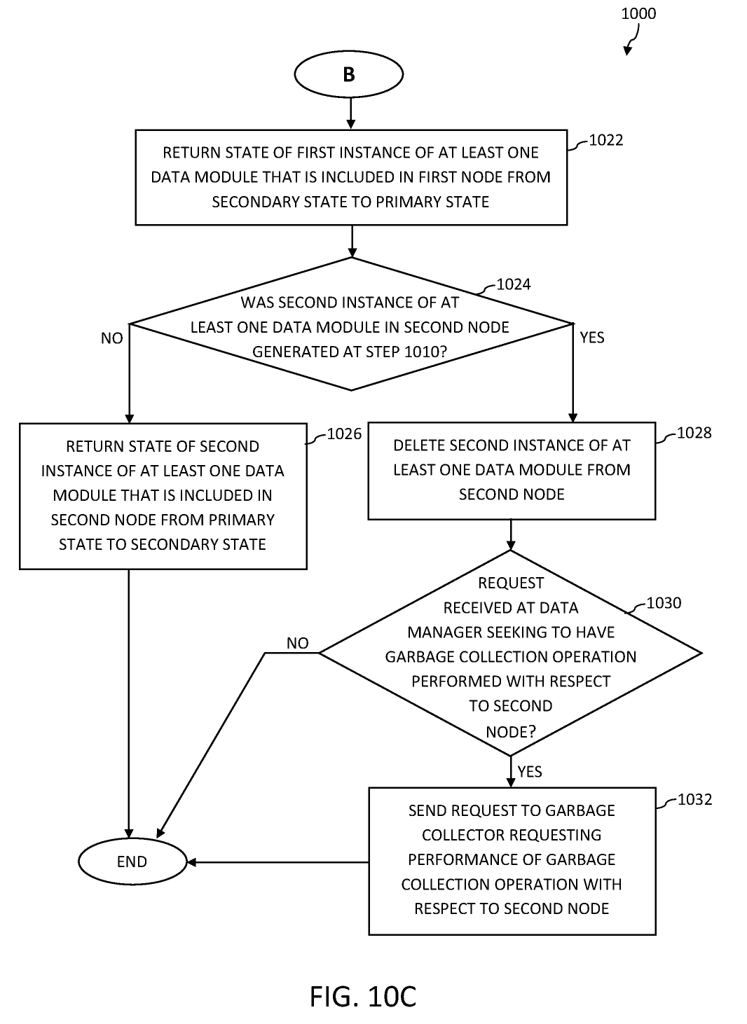

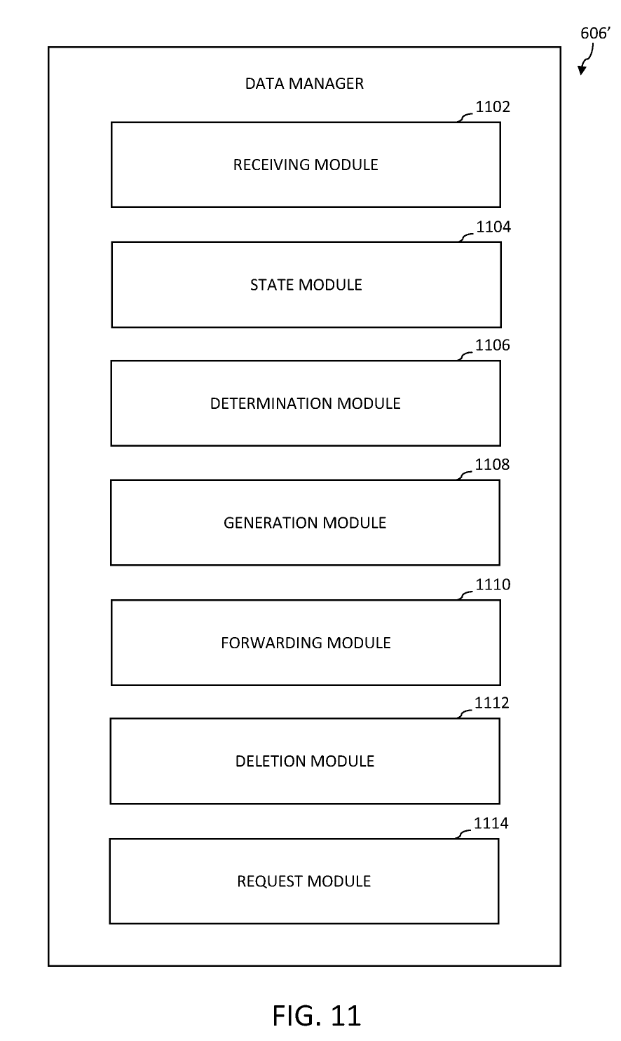

FIGS. 10A-10C depict respective portions of a flowchart of a method for managing access to a distributed cache during a garbage collection operation in accordance with an embodiment. Flowchart 1000 is described from the perspective of a data manager. Flowchart 1000 may be performed by data manager 606 of computer system 600 shown in FIG. 6, for example. For illustrative purposes, flowchart 1000 is described with respect to a data manager 606′ shown in FIG. 11, which is an example of a data manager 606, according to an embodiment. As shown in FIG. 11, data manager 606′ includes a receiving module 1102, a state module 1104, a determination module 1106, a generation module 1108, a forwarding module 1110, a deletion module 1112, and a request module 1114. Further structural and operational embodiments will be apparent to persons skilled in the relevant art(s) based on the discussion regarding flowchart 1000. Flowchart 1000 is described as follows.

As shown in FIG. 10A, the method of flowchart 1000 begins at step 1002. In step 1002, a request is received from a first node of a distributed cache to place the first node in an offline state prior to execution of a garbage collection operation with respect to the first node. A node is in an offline state when all instances of data modules that are included in that node are in the secondary state. For instance, such instances of the data modules may be inaccessible to applications that attempt to access data that is included in the data modules. In an example implementation, receiving module 1102 receives the request from the first node.

At step 1004, a state of a first instance of at least one data module that is included in the first node is changed from a primary state to a secondary state, using at least one processor of a data manager, in response to receiving the request. For example, the data manager may change any instance of a data module included in the first node that is in the primary state to the secondary state. In another example, the data manager may change an instance of one or more selected data module(s) included in the first node that are in the primary state to the secondary state. In an example implementation, state module 1104 changes the state of the first instance of the at least one data module that is included in the first node from the primary state to the secondary state.

The primary state of the first instance indicates that cache operation(s) with respect to the at least one data module are to be initiated at or initially directed to the first instance of the at least one data module that is included in the first node. The secondary state of the first instance indicates that the cache operation(s) with respect to the at least one data module are not to be initiated at or initially directed to the first instance of the at least one data module that is included in the first node.

At step 1006, a determination is made whether to maintain availability of the at least one data module during the garbage collection operation. In an example implementation, determination module 1106 determines whether to maintain availability of the at least one data module. If availability of the at least one data module is not to be maintained during the garbage collection operation, flowchart 1000 ends. If availability of the at least one data module is to be maintained, however, flow continues to step 1008.

At step 1008, a determination is made whether a second node of the distributed cache includes a second instance of the at least one data module. For instance, the determination may be made whether any node of the distributed cache other than the first node includes one or more instances of the at least one data module that are not locked by a garbage collection operation. In an example implementation, determination module 1106 determines whether the second node includes a second instance of the at least one data module. If the second node includes a second instance of the at least one data module, flow continues to step 1012. If the second node does not include a second instance of the at least one data module, however, flow continues to step 1010.

At step 1010, the second instance of the at least one data module in the second node is generated. For instance, the second node may be a node of the distributed cache upon which a garbage collection operation is not being performed. In an example implementation, generation module 1108 generates the second instance of the at least one data module in the second node.

At step 1012, a state of the second instance of the at least one data module that is included in the second node is changed from the secondary state to the primary state. The primary state of the second instance indicates that cache operation(s) with respect to the at least one data module are to be initiated at or initially directed to the second instance of the at least one data module that is included in the second node. The secondary state of the second instance indicates that the cache operation(s) with respect to the at least one data module are not to be initiated at or initially directed to the second instance of the at least one data module that is included in the second node.

For instance, changing the state of the second instance of the at least one data module that is included in the second node to the primary state may enable the data that is included in the data module to be available during the garbage collection operation. In an example implementation, state module 1104 changes the state of the second instance of the at least one data module that is included in the second node from the secondary state to the primary state. Upon performance of step 1012, flow continues to step 1014, which is shown in FIG. 10B.

At step 1014, a determination is made as to whether write requests that are directed to the second instance of the at least one data module that is included in the second node are to be forwarded for logging in a third node of the distributed cache. For example, a third instance of the at least one data module that is included in the third node may maintain a log of all changes that are to be made to the data module with respect to the write requests. The log may be maintained for the purpose of recovering information regarding the changes in the event that the second instance becomes inaccessible, for example. In an example implementation, determination module 1106 determines whether to forward the write requests for logging in the third node. If the write requests are not to be forwarded to the third node, flow continues to step 1018. Otherwise, continues to step 1016.

At step 1016, the write requests are forwarded to the third node for logging. In an example implementation, forwarding module 1110 forwards the write requests to the third node.

At step 1018, a determination is made as to whether the garbage collection operation is complete with respect to the first node. For instance, a garbage collector (e.g., garbage collector 604) that performs the garbage collection operation may provide an indicator to the first node indicating that the garbage collection operation is complete with respect to the first node in response to completion of the garbage collection operation with respect to the first node. In an example implementation, determination module 1106 determines whether the garbage collection operation is complete. If the garbage collection operation is not complete flow returns to step 1018. Otherwise, flow continues to step 1020.

At step 1020, a determination is made as to whether the state of the first instance of the at least one data module that is included in the first node is to be returned to the primary state. For instance, the determination may be based on whether a request is received seeking to have the state of the first instance of the at least one data module that is included in the first node returned to the primary state. The first node, the second node, or another node of the distributed cache that is configured to communicate with the data manager may provide such a request upon completion of the garbage collection operation with respect to the first node. In an example implementation, determination module 1106 determines whether the state of the first instance of the at least one data module that is included in the first node is to be returned to the primary state. If the state of the first instance of the at least one data module that is included in the first node is not to be returned to the primary state, flowchart 1000 ends. Otherwise, flow continues to step 1022, which is shown in FIG. 10C.

At step 1022, the state of the first instance of the at least one data module that is included in the first node is returned from the secondary state to the primary state. In an example implementation, state module 1104 returns the state of the first instance of the at least one data module that is included in the first node from the secondary state to the primary state.

At step 1024, a determination is made as to whether the second instance of the at least one data module in the second node was generated at step 1010. For example, an indicator may be set upon completion of step 1010 to have a value that indicates that step 1010 was performed. In accordance with this example, the determination at step 1024 may be based on the value of the indicator. In an example implementation, determination module 1106 determines whether the second instance of the at least one data module in the second node was generated at step 1010. If the second instance of the at least one data module was generated in the second node at step 1010, flow continues to step 1028. Otherwise, flow continues to step 1026.

At step 1026 the state of the second instance of the at least one data module that is included in the second node is returned from the primary state to the secondary state. In an example implementation, state module 1104 returns the state of the second instance of the at least one data module that is included in the second node from the primary state to the secondary state. Upon performance of step 1026, flowchart 1000 ends.

At step 1028, the second instance of the at least one data module is deleted from the second node. In an example implementation, deletion module 1112 deletes the second instance of the at least one data module from the second node. It will be recognized that the second instance of the at least one data module that is included in the second node need not necessarily be deleted. For example, the state of the second instance of the at least one data module that is included in the second node may be placed in the secondary state, rather than being deleted. In accordance with this example, after completion of step 1022, flow would continue in every case to step 1026, and flowchart 1000 would thereafter end.

At step 1030, a determination is made as to whether a request is received at the data manager seeking to have a garbage collection operation performed with respect to the second node. For instance, the request may be received from the first node, the second node, or another node that is configured to communicate with the data manager. In an example implementation, determination module 1106 determines whether a request is received at data manager 606′ seeking to have a garbage collection operation performed with respect to the second node. If such a request is not received, flowchart 1000 ends. However, if such a request is received, flow continues to step 1032.

At step 1032, a request is sent to a garbage collector requesting performance of a garbage collection operation with respect to the second node. For instance, after performance of step 1028 in which the second instance of the at least one data module is deleted from the second node, the second instance may still exist on the second node, though the second instance can no longer be referenced by any application. Accordingly, performance of the garbage collection operation with respect to the second node may physically remove the second instance from the second node. In an example implementation, request module 1114 sends the request to the garbage collector requesting performance of a garbage collection operation with respect to the second node.

In some example embodiments, one or more steps 1002, 1004, 1006, 1008, 1010, 1012, 1014, 1016, 1018, 1020, 1022, 1024, 1026, 1028, 1030, and/or 1032 of flowchart 1000 may not be performed. Moreover, steps in addition to or in lieu of steps 1002, 1004, 1006, 1008, 1010, 1012, 1014, 1016, 1018, 1020, 1022, 1024, 1026, 1028, 1030, and/or 1032 may be performed.

It will be recognized that data manager 606′ may not include one or more of receiving module 1102, state module 1104, determination module 1106, generation module 1108, forwarding module 1110, deletion module 1112, and/or request module 1114. Furthermore, data manager 606′ may include modules in addition to or in lieu of receiving module 1102, state module 1104, determination module 1106, generation module 1108, forwarding module 1110, deletion module 1112, and/or request module 1114.

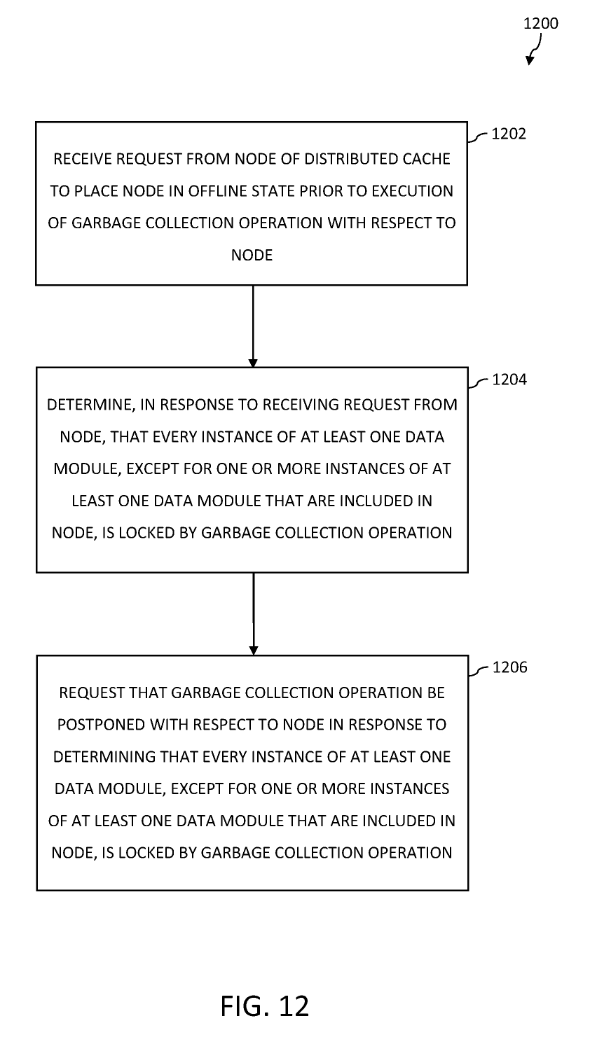

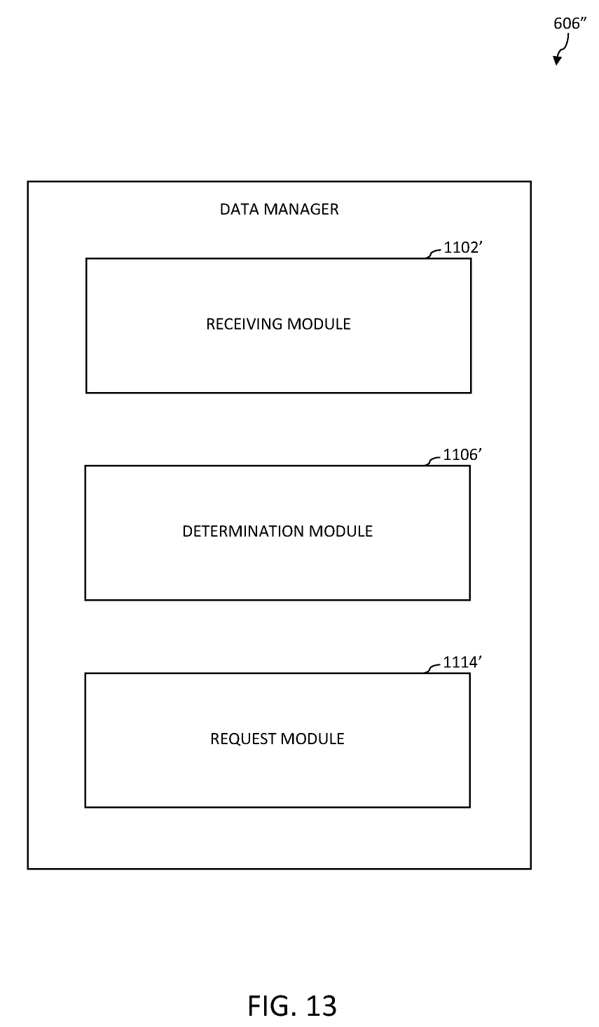

FIG. 12 depicts a flowchart 1200 of a method for managing access to a distributed cache during a garbage collection operation in accordance with an embodiment. Flowchart 1200 is described from the perspective of a data manager. Flowchart 1200 may be performed by data manager 606 of computer system 600 shown in FIG. 6, for example. For illustrative purposes, flowchart 1200 is described with respect to a data manager 606″ shown in FIG. 13, which is an example of a data manager 606, according to an embodiment. As shown in FIG. 13, data manager 606″ includes a receiving module 1102′, a determination module 1106′, and a request module 1114′. Further structural and operational embodiments will be apparent to persons skilled in the relevant art(s) based on the discussion regarding flowchart 1200. Flowchart 1200 is described as follows.

As shown in FIG. 12, the method of flowchart 1200 begins at step 1202. In step 1202, a request is received from a node of a distributed cache to place the node in an offline state prior to execution of a garbage collection operation with respect to the node. In an example implementation, receiving module 1102′ receives the request from the node to place the node in the offline state.

At step 1204, a determination is made, in response to receiving the request from the second node, that every instance of the at least one data module except for one or more instances of the at least one data module that are included in the node is locked by the garbage collection operation. A locked data module is a data module upon which a garbage collection operation is being performed. For instance, the determination at step 1204 may be based on indicator(s) received from a garbage collector (e.g., garbage collector 604) or node(s) (e.g., any of nodes 614A-614N) of the distributed cache that indicate the data modules (e.g., any of data modules 616A-616N) upon which a garbage collection operation is being performed. In an example implementation, determination module 1106′ determines that every instance of the at least one data module except for one or more instances of the at least one data module that are included in the node is locked by the garbage collection operation. For instance, one or more processors of data manager 606″ may be used to make the determination.

At step 1206, a request is made that the garbage collection operation be postponed with respect to the node in response to the determining that every instance of the at least one data module except for one or more instances of the at least one data module that are included in the node is locked by the garbage collection operation. In an example implementation, request module 1114′ requests that the garbage collection operation be postponed with respect to the first node.

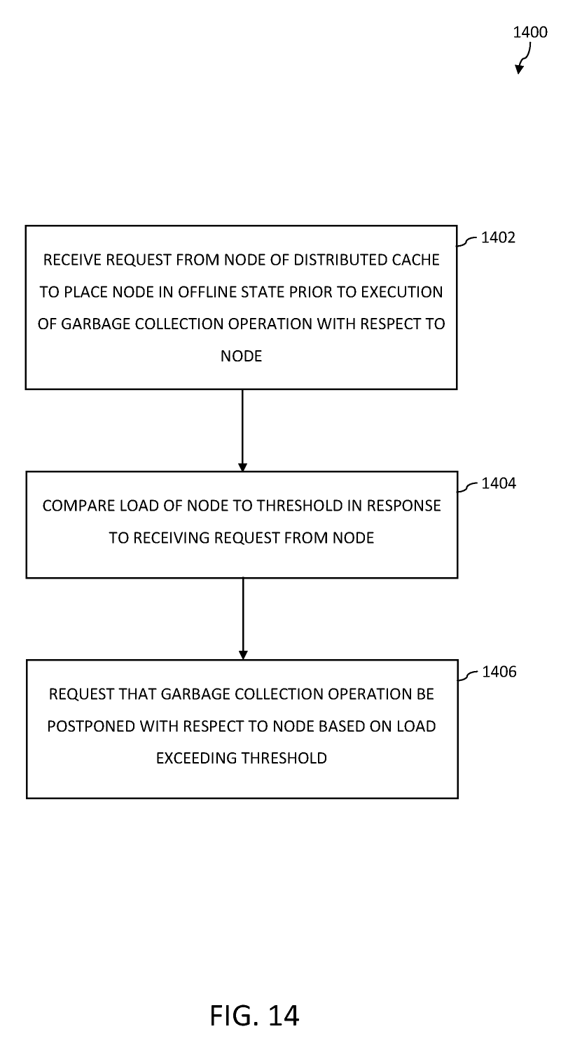

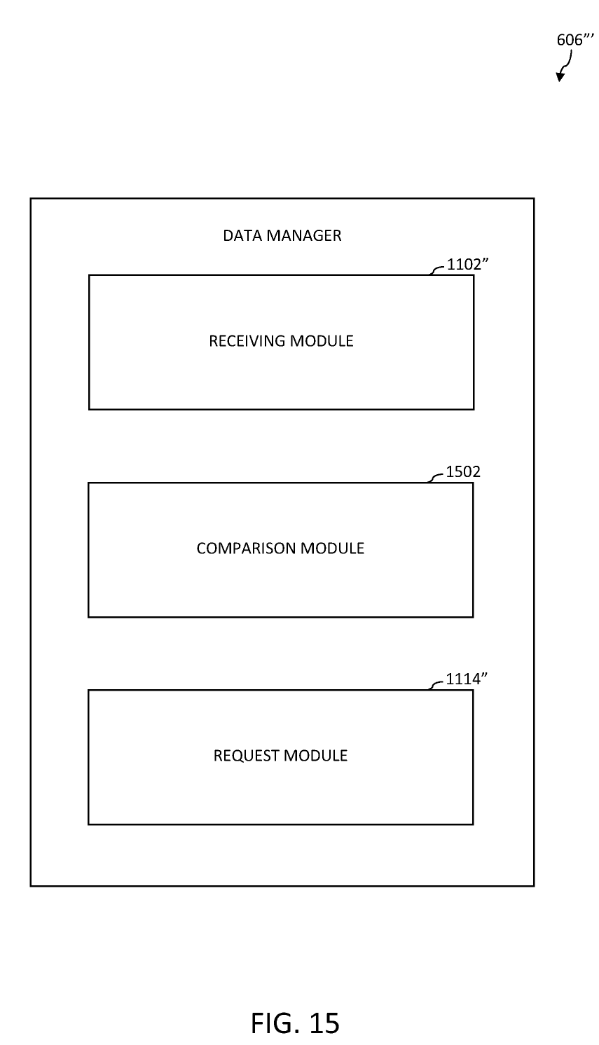

FIG. 14 depicts a flowchart 1400 of another method for managing access to a distributed cache during a garbage collection operation in accordance with an embodiment. Flowchart 1400 is described from the perspective of a data manager. Flowchart 1400 may be performed by data manager 606 of computer system 600 shown in FIG. 6, for example. For illustrative purposes, flowchart 1400 is described with respect to a data manager 606′″ shown in FIG. 15, which is an example of a data manager 606, according to an embodiment. As shown in FIG. 15, data manager 606′″ includes a receiving module 1102″, a comparison module 1502, and a request module 1114″. Further structural and operational embodiments will be apparent to persons skilled in the relevant art(s) based on the discussion regarding flowchart 1400. Flowchart 1400 is described as follows.

As shown in FIG. 14, the method of flowchart 1400 begins at step 1402. In step 1402, a request is received from a node of a distributed cache to place the node in an offline state prior to execution of a garbage collection operation with respect to the node. In an example implementation, receiving module 1102″ receives the request from the node to place the node in the offline state.

At step 1404, a load of the node is compared to a threshold in response to receiving the request from the node. The load may be based on the number of requests that are processed by the node in a designated period of time, a proportion of the node's bandwidth that is being consumed, and/or any other suitable factor(s). In an example implementation, comparison module 1502 compares the load of the node to the threshold.

At step 1406, a request is made that the garbage collection operation be postponed with respect to the node based on the load exceeding the threshold. In accordance with some embodiments, a relatively high load may indicate that the node serves as the primary node for a substantial amount of data. For example, performing the garbage collection operation with respect to the node may lock the primary instances of the data that are included in the node. In accordance with this example, performing the garbage collection operation with respect to the node would render the data inaccessible because the primary instances would be locked by the garbage collection operation. In another example, the state of the primary instances that are included in the node may be changed to a secondary state, and another instance of the data included in another node (or a plurality of instances of respective portions of the data included in a single node or across multiple nodes) may be changed to the primary state. In accordance with this example, substantial resources may be necessary to change the states of the primary instances that are included in the node to the secondary state and the other instance(s) that are included in the other node(s) to the primary state. In an example implementation, request module 1114″ requests that the garbage collection operation be postponed with respect to the node.

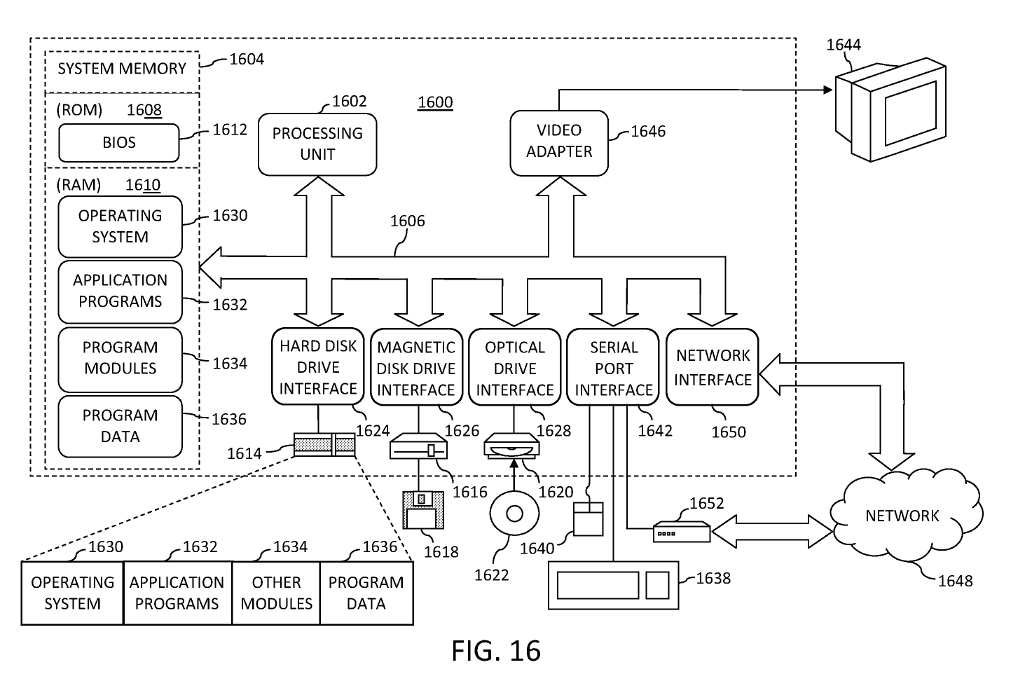

FIG. 16 depicts an example computer 1600 in which embodiments may be implemented. Any one or more of the machines 102A-102N shown in FIGS. 1 and 6, user systems 602A-602M, garbage collector 604, data manager 606, or database 610 shown in FIG. 6, or any one or more subcomponents thereof shown in FIGS. 9, 11, 13, and 15 may be implemented using computer 1600, including one or more features of computer 1600 and/or alternative features. Computer 1600 may be a general-purpose computing device in the form of a conventional personal computer, a mobile computer, or a workstation, for example, or computer 1600 may be a special purpose computing device. The description of computer 1600 provided herein is provided for purposes of illustration, and is not intended to be limiting. Embodiments may be implemented in further types of computer systems, as would be known to persons skilled in the relevant art(s).

As shown in FIG. 16, computer 1600 includes a processing unit 1602, a system memory 1604, and a bus 1606 that couples various system components including system memory 1604 to processing unit 1602. Bus 1606 represents one or more of any of several types of bus structures, including a memory bus or memory controller, a peripheral bus, an accelerated graphics port, and a processor or local bus using any of a variety of bus architectures. System memory 1604 includes read only memory (ROM) 1608 and random access memory (RAM) 1610. A basic input/output system 1612 (BIOS) is stored in ROM 1608.

Computer 1600 also has one or more of the following drives: a hard disk drive 1614 for reading from and writing to a hard disk, a magnetic disk drive 1616 for reading from or writing to a removable magnetic disk 1618, and an optical disk drive 1620 for reading from or writing to a removable optical disk 1622 such as a CD ROM, DVD ROM, or other optical media. Hard disk drive 1614, magnetic disk drive 1616, and optical disk drive 1620 are connected to bus 1606 by a hard disk drive interface 1624, a magnetic disk drive interface 1626, and an optical drive interface 1628, respectively. The drives and their associated computer-readable storage media provide nonvolatile storage of computer-readable instructions, data structures, program modules and other data for the computer. Although a hard disk, a removable magnetic disk and a removable optical disk are described, other types of computer-readable media can be used to store data, such as flash memory cards, digital video disks, random access memories (RAMs), read only memories (ROM), and the like.

A number of program modules may be stored on the hard disk, magnetic disk, optical disk, ROM, or RAM. These programs include an operating system 1630, one or more application programs 1632, other program modules 1634, and program data 1636. Application programs 1632 or program modules 1634 may include, for example, computer program logic for implementing nodes 104A-104Z, named caches 106A-106B, regions 108A-108Y, cache items 110A-110P, cache clients 202A-202B, routing layers 204A-204C, Put operation 206, Get operation 208, primary data modules 210A-210C, secondary data modules 302A-302C, replicated data modules 402A-402C, local caches 502A-502B, routing layers 504A-504B, nodes 614A-614N, data module(s) 616A-616N, application(s) 618A-618N, receiving module 902, request module 904, receiving module 1102, state module 1104, determination module 1106, generation module 1108, forwarding module 1110, deletion module 1112, request module 1114, comparison module 1502, flowchart 700 (including any step of flowchart 700), flowchart 800 (including any step of flowchart 800), flowchart 1000 (including any step of flowchart 1000), flowchart 1200 (including any step of flowchart 1200), and/or flowchart 1400 (including any step of flowchart 1400), as described herein.

A user may enter commands and information into the computer 1600 through input devices such as keyboard 1638 and pointing device 1640. Other input devices (not shown) may include a microphone, joystick, game pad, satellite dish, scanner, or the like. These and other input devices are often connected to the processing unit 1602 through a serial port interface 1642 that is coupled to bus 1606, but may be connected by other interfaces, such as a parallel port, game port, or a universal serial bus (USB).

A monitor 1644 or other type of display device is also connected to bus 1606 via an interface, such as a video adapter 1646. In addition to the monitor, computer 1600 may include other peripheral output devices (not shown) such as speakers and printers.

Computer 1600 is connected to a network 1648 (e.g., the Internet) through a network interface or adapter 1650, a modem 1652, or other means for establishing communications over the network. Modem 1652, which may be internal or external, is connected to bus 1606 via serial port interface 1642.

As used herein, the terms “computer program medium” and “computer-readable medium” are used to generally refer to media such as the hard disk associated with hard disk drive 1614, removable magnetic disk 1618, removable optical disk 1622, as well as other media such as flash memory cards, digital video disks, random access memories (RAMs), read only memories (ROM), and the like.

As noted above, computer programs and modules (including application programs 1632 and other program modules 1634) may be stored on the hard disk, magnetic disk, optical disk, ROM, or RAM. Such computer programs may also be received via network interface 1650 or serial port interface 1642. Such computer programs, when executed or loaded by an application, enable computer 1600 to implement features of embodiments discussed herein. Accordingly, such computer programs represent controllers of the computer 1600.

Embodiments are also directed to computer program products comprising software (e.g., computer-readable instructions) stored on any computer usable medium. Such software, when executed in one or more data processing devices, causes a data processing device(s) to operate as described herein. Embodiments may employ any computer-usable or computer-readable medium, known now or in the future. Examples of computer-readable mediums include, but are not limited to storage devices such as RAM, hard drives, floppy disks, CD ROMs, DVD ROMs, zip disks, tapes, magnetic storage devices, optical storage devices, MEMS-based storage devices, nanotechnology-based storage devices, and the like.

### IV. Conclusion

While various embodiments have been described above, it should be understood that they have been presented by way of example only, and not limitation. It will be apparent to persons skilled in the relevant art(s) that various changes in form and details can be made therein without departing from the spirit and scope of the invention. Thus, the breadth and scope of the present invention should not be limited by any of the above-described exemplary embodiments, but should be defined only in accordance with the following claims and their equivalents.

What is claimed is:

1. A method comprising:
receiving a request from a first node of a distributed cache to place the first node in an offline state prior to execution of a garbage collection operation with respect to the first node; and
changing a state of a first instance of at least one data module that is included in the first node from a primary state to a secondary state, using at least one processor, in response to receiving the request, the primary state of the first instance indicating that a cache operation with respect to the at least one data module is to be initiated at or initially directed to the first instance of the at least one data module, and the secondary state of the first instance indicating that the cache operation with respect to the at least one data module is not to be initiated at or initially directed to the first instance.

2. The method of claim 1, further comprising:
changing a state of a second instance of the at least one data module that is included in a second node of the distributed cache from the secondary state to the primary state in response to receiving the request, the primary state of the second instance indicating that a cache operation with respect to the at least one data module is to be initiated at or initially directed to the second instance of the at least one data module, and the secondary state of the second instance indicating that the cache operation with respect to the at least one data module is not to be initiated at or initially directed to the second instance.

3. The method of claim 2, further comprising:
forwarding write requests that are directed to the second instance of the at least one data module that is included in the second node for logging on a third node of the distributed cache.

4. The method of claim 2, further comprising:
returning the state of the first instance of the at least one data module that is included in the first node from the secondary state to the primary state in response to completion of the garbage collection operation; and
returning the state of the second instance of the at least one data module that is included in the second node from the primary state to the secondary state in response to completion of the garbage collection operation.

5. The method of claim 2, further comprising:
generating the second instance of the at least one data module in the second node in response to receiving the request;
wherein the changing the state of the second instance of the at least one data module is performed in response to the generating the second instance of the at least one data module.

6. The method of claim 5, further comprising:
returning the state of the first instance of the at least one data module of the first node from the secondary state to the primary state in response to completion of the garbage collection operation; and
deleting the second instance of the at least one data module from the second node in response to completion of the garbage collection operation.

7. The method of claim 6, further comprising:
requesting performance of a garbage collection operation with respect to the second node in response to the deleting the second instance of the at least one data module from the second node.

8. The method of claim 1, further comprising:
receiving a request from a second node of the distributed cache to place the second node in an offline state prior to execution of the garbage collection operation with respect to the second node;
determining, in response to receiving the request from the second node, that every instance of the at least one data module, except for one or more second instances of the at least one data module that are included in the second node, is locked by the garbage collection operation; and
requesting that the garbage collection operation be postponed with respect to the second node in response to determining that every instance of the at least one data module, except for the one or more second instances of the at least one data module that are included in the second node, is locked by the garbage collection operation.

9. The method of claim 1, further comprising:
receiving a request from a second node of the distributed cache to place the second node in an offline state prior to execution of the garbage collection operation with respect to the second node;
comparing a load of the second node to a threshold in response to receiving the request from the second node; and
requesting that the garbage collection operation be postponed with respect to the second node based on the load exceeding the threshold.

10. The method of claim 1, wherein the cache operation with respect to the at least one data module is a write request with respect to the at least one data module.

11. A data manager comprising:
a receiving module configured to receive a request from a first node of a distributed cache to place the first node in an offline state prior to execution of a garbage collection operation with respect to the first node; and
a state module configured to change a state of a first instance of at least one data module that is included in the first node from a primary state to a secondary state in response to the request, the primary state of the first instance indicating that a cache operation with respect to the at least one data module is to be initiated at or initially directed to the first instance of the at least one data module, and the secondary state of the first instance indicating that the cache operation with respect to the at least one data module is not to be initiated at or initially directed to the first instance.

12. The data manager of claim 11, wherein the state module is further configured to change a state of a second instance of the at least one data module that is included in a second node of the distributed cache from the secondary state to the primary state in response to receiving the request, the primary state of the second instance indicating that a cache operation with respect to the at least one data module is to be initiated at or initially directed to the second instance of the at least one data module, and the secondary state of the second instance indicating that the cache operation with respect to the at least one data module is not to be initiated at or initially directed to the second instance.

13. The data manager of claim 12, further comprising:
a forwarding module configured to forward write requests that are directed to the second instance of the at least one data module that is included in the second node for logging on a third node of the distributed cache.

14. The data manager of claim 12, wherein the state module is further configured to return the state of the first instance of the at least one data module that is included in the first node from the secondary state to the primary state in response to completion of the garbage collection operation; and
wherein the state module is further configured to return the state of the second instance of the at least one data module that is included in the second node from the primary state to the secondary state in response to completion of the garbage collection operation.

15. The data manager of claim 12, further comprising:
a generation module configured to generate the second instance of the at least one data module in the second node in response to receiving the request;
wherein the stated module is configured to change the state of the second instance of the at least one data module in response to generation of the second instance of the at least one data module.

16. The data manager of claim 15, further comprising:
a deletion module configured to delete the second instance of the at least one data module from the second node in response to completion of the garbage collection operation;
wherein the state module is further configured to return the state of the first instance of the at least one data module of the first node from the secondary state to the primary state in response to completion of the garbage collection operation.

17. The data manager of claim 16, further comprising:
a requesting module configured to request performance of a garbage collection operation with respect to the second node in response to deletion of the second instance of the at least one data module from the second node and further in response to a request from at least one of the first node or the second node that the garbage collection operation be performed with respect to the second node.

18. The data manager of claim 11, wherein the receiving module is further configured to receive a request from a second node of the distributed cache to place the second node in an offline state prior to execution of the garbage collection operation with respect to the second node; and
wherein the data manager further comprises:
a determination module configured to determine that every instance of the at least one data module except for one or more second instances of the at least one data module that are included in the second node is locked by the garbage collection operation; and
a request module configured to request that the garbage collection operation be postponed with respect to the second node in response to determination that every instance of the at least one data module except for the one or more second instances of the at least one data module that are included in the second node is locked by the garbage collection operation.

19. The data manager of claim 11, wherein the receiving module is further configured to receive a request from a second node of the distributed cache to place the second node in an offline state prior to execution of the garbage collection operation with respect to the second node; and
wherein the data manager further comprises:
a comparison module configured to compare a load of the second node to a threshold in response to receiving the request from the second node; and
a request module configured to request that the garbage collection operation be postponed with respect to the second node based on the load exceeding the threshold.

20. A method comprising:
receiving a request from a node of a distributed cache to place the node in an offline state prior to execution of a garbage collection operation with respect to the node;
determining, in response to receiving the request from the node, that every instance of the at least one data module, except for one or more instances of the at least one data module that are included in the node, is locked by the garbage collection operation; and
requesting that the garbage collection operation be postponed with respect to the node in response to determining that every instance of the at least one data module, except for the one or more instances of the at least one data module that are included in the node, is locked by the garbage collection operation.
